(19) United States
(12) Patent Application Publication
(10) Pub. No.: US 2007/0147038 A1
(43) Pub. Date: Jun. 28, 2007

(54) Fire extinguisher

(76) Inventor: Lee Bahorun, West Sussex (GB)

Correspondence Address: BLANK ROME LLP, 600 NEW HAMPSHIRE AVENUE, N.W., WASHINGTON, DC, 20037, US

(21) Appl. No.: 10/576,713

(22) PCT Filed: Oct. 8, 2004
(86) PCT No.: PCT/GB04/04325

§ 371 Date: Nov. 17, 2006

(30) Foreign Application Priority Data
Oct. 21, 2003 (GB) 0324508.1
Oct. 28, 2003 (GB) 0325078.4

(51) Int. Cl. F21V 33/00

(52) U.S. Cl. 362/253; 340/693.5; 340/693.2; 169/51; 362/276

(57) ABSTRACT

A fire extinguisher having at least one indicating device located thereon that provides a visual and/or audio signal to allow a user to quickly locate the fire extinguisher in an emergency.

The present invention relates to a fire extinguisher.

Fires continue to destroy the possessions and lives of everyday people. The majority of buildings, including private homes, contain one or more fire extinguishers for use in an emergency to prevent spread of fire, at least until the fire service can be contacted and arrive to control and stop the fire. Fire extinguishers contain various materials, for example, water, carbon dioxide, powder or halon to combat fires of different types. The different materials contained within each fire extinguisher cylinder are generally characterised by a prominent colour on the fire extinguisher.

Fire extinguishers, by law, should be kept in a prominent place near to each fire exit of the building. They need to be easily accessible to anyone should they need to use the fire extinguisher in an emergency.

Through his own experience, the present applicant has discovered an important problem with fire extinguishers currently available and being used, to which this application is addressed.

The particular problem with fire extinguishers on the market relates to the ability to locate the fire extinguisher in the event of a fire. Although every person in the building should be aware of the location of the fire extinguisher on a day-to-day basis, thick smoke produced by a fire prevents the location to be found easily and quickly. Moreover, the ensuing panic of a person not trained in fire situations, commonly results in severe disorientation to the extent that the person is unable to work out where they are in the building in relation to the fire extinguisher.

Furthermore, even when the fire extinguisher is located, the pin of the fire extinguisher often cannot be easily located due to the extreme visibility problems caused by the thick smoke. In such a situation, it is usually the case that everything, including the fire extinguisher cylinder, the pin and indeed the hands of the person trying to use the extinguisher, are quickly covered in a dense black residue. Consequently, specific parts of extinguisher are not easy to find in a few seconds. Vital seconds, and even minutes are therefore lost in trying to activate the fire extinguisher, at least to help in being able to reach the fire exit, or contain the fire until help arrives.

The present invention seeks to alleviate the problem described above by providing a fire extinguisher which has a visual or oral indicator to allow the location fire extinguisher to be easily assessed in an emergency situation. Furthermore, as, by law, fire extinguishers must be located in the vicinity of a fire exit of a building, locating the position of the fire extinguishers will also aid the location of the fire exit.

The term “fire extinguisher” is intended to embrace any apparatus capable of extinguishing fire, including a fire hose.

According to one aspect, there is provided a fire extinguisher comprising a cylindrical body, a handle and a pin, the extinguisher having at least one indicating device mounted thereon to provide a clear indication as to the location of the fire extinguisher.

Preferably, the indicating device provides a visual indication of the location of the fire extinguisher. Alternatively the indication device comprises an audio indication, or a combination of visual and audio indication.

Preferably, the, or at least one indication device is an LED. Preferably still, the or each LED provides a colour that corresponds with a representative colour of the material contained within the extinguisher cylinder.

Preferably still the or one indication device is mounted on, or in the immediate vicinity of, the pin. Preferably still, an Indication device is mounted either side of the pin.

In a preferred embodiment, at least one indication device is mounted on a side surface of the extinguisher, preferably near the base thereof. The or each indication device is an LED that is preferably in a position whereupon light is transmitted from the LED to a person in the vicinity of the extinguisher without obstruction.

Preferably, the or each indication device is an LED mounted on a strip.

Preferably still, the strip includes means to power the or each LED. The strip also, preferably, includes means to attach the strip to a fire extinguisher. Preferably, the attachment means takes the form of a suitable adhesive, alternatively the attachment means may take the form of a male/female linking mechanism.

According to a second aspect, there is provided a stand for a fire extinguisher the stand having a surface not obstructed by the fire extinguisher located on the stand in use, the surface having at least one indicating device mounted thereon to provide a clear indication as to the location of the fire extinguisher stand.

The invention will now be described by way of example with reference to the accompanying diagrammatic drawings, in which:—

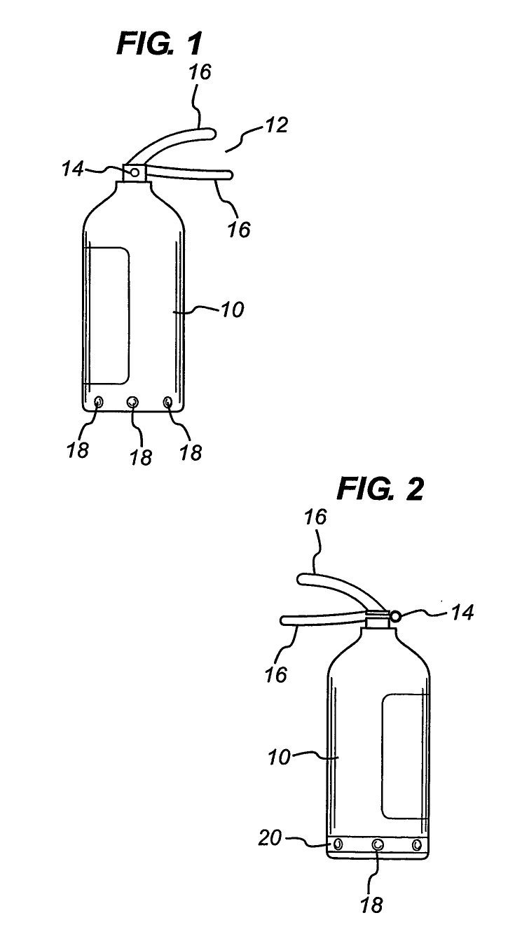

FIG. 1 is a side view of a fire extinguisher constructed in accordance with the present invention;

FIG. 2 is a side view of a further embodiment of a fire extinguisher constructed in accordance with the present invention;

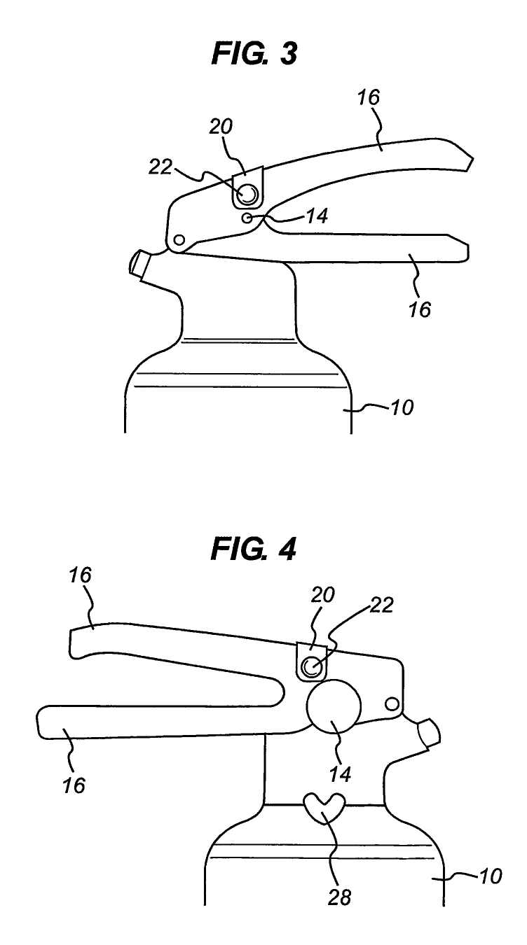

FIG. 3 is a side view of a handle and pin of the fire extinguisher of FIG. 1 or 2;

FIG. 4 is a view from the other side of the handle and pin of the fire extinguisher of FIG. 3;

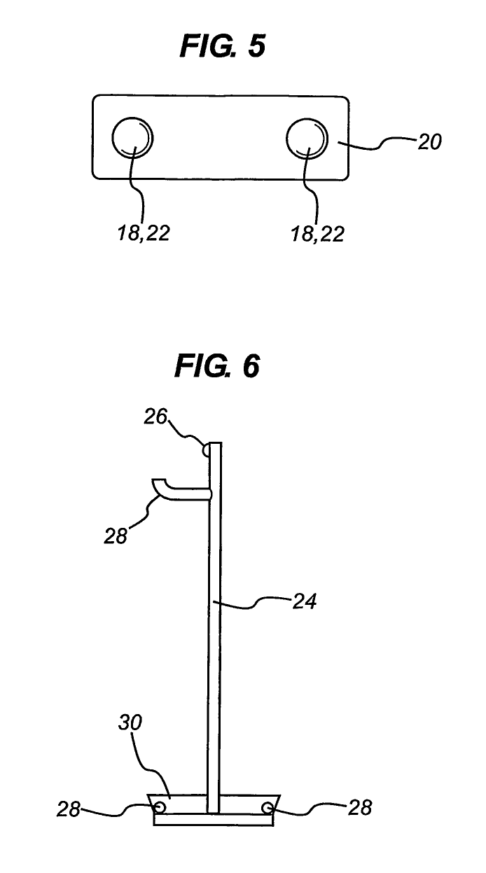

FIG. 5 is a plan view of an indicating device constructed in accordance with the present invention; and

FIG. 6 is a side view of a stand constructed in accordance with the present invention.

Referring first to FIG. 1, a fire extinguisher comprises a cylinder 10, a handle 12 and a pin 14. The handle 12 comprises two arms 16 which provide the activation means when the pin 14 is removed.

As can be seen from FIG. 1, a side surface of the cylinder 10 has a plurality of indicating devices in the form of LEDs 18 mounted thereon. A line of LEDs 18 extends around the entire circumference of the cylinder 10. The LEDs 18 may be individually mounted on the cylinder 10 or, alternatively, may be embedded within, or formed integral with, the outer surface of the cylinder 10.

The LEDs 18 may be chosen to transmit the colour which is associated to the material contained within the cylinder 10 of the fire extinguisher. Consequently, a person is able to tell the type of each fire extinguisher, and therefore choose the correct extinguisher to be used in the circumstances, by the colour transmitted by the LEDs 18.

The line of LEDs 18 is preferably located near the bottom of the cylinder 10, due to the fact that smoke rises and, as such, it is more likely that the LEDs 18 will be visible at low level. Moreover, the fact that the LEDs 18 are provided low to the floor means that at least part of a pathway directed towards the fire exit is illuminated and, as such is visible in a fire situation.

It is, however, clearly the case that the LEDs 18 could be located anywhere on the outer surface of the cylinder 10 provided that they are visible from a good distance away from the cylinder 10. Moreover, the LEDs 18 may not be formed in a line, as is shown in FIG. 1, the LEDs 18 may instead be Individually located at various positions on the cylinder 10 surface.

In an alternative embodiment, shown in FIGS. 2 and 5, the LEDs 18 are mounted on a strip 20 which is, in turn, mounted on the cylinder 10. The strip 10 may be mounted on the cylinder 10 using a suitable adhesive or, alternatively, may be mounted via a male/female link mechanism, such as that which is marketed under the name VELCRO®. In this case, one member of the link mechanism is mounted on the cylinder 10 which then engages with the other link member incorporated on the strip 20 to mount the LEDs 18 on the cylinder 10.

The strip 20 may be a solar strip to provide solar power to the LEDs 18 mounted on the strip 20. Alternatively, the strip 20 may additionally hold a battery (not shown) to power the LEDs 18. In a preferred embodiment, the battery has a life of approximately one year. As such, it would be possible to synchronise the life of the battery with the annual service of the fire extinguisher on which the strip 20 and LEDs 18 are mounted in such a way that a powerless LED 18 indicates that the fire extinguisher is due for its annual service.

FIGS. 3 and 4 show the “working end” of the fire extinguisher. Here, an LED 22 is provided directly above the location of the pin 14 on each side of the handle 12. The LEDs 22 are incorporated on a strip 20 as described above such that the strip 20 extends across the top of the handle and down each side towards the area of the pin 14. The strip 20 may be mounted on the fire extinguisher in a way already described. In a further embodiment (not shown) the LEDs 22 are embedded into, or formed integral with the outer surface of the cylinder 10 in the locations shown in FIGS. 3 and 4. A further LED (not shown) may also be located on the pin 14 itself. The location of the LEDs 22 provides illumination to the area of the pin 14, while also relecting light to the hand of a person attempting to locate the pin 14, thus allowing the pin 14 to be found easily and quickly in order to activate the fire extinguisher in an emergency.

FIG. 6 shows a stand 24 that can be used in conjunction with such a fire extinguisher. It will be appreciated that the stand 24 is only illustrated and described in a basic form and that the invention can be applied to any type of stand suitable for holding a fire extinguisher.

The stand 24 has an LED 26 formed or mounted in a top portion. The LED 26 should be located in a position sufficiently high that the LED 26 is not obstructed from view when a fire extinguisher is placed on the stand 26 and held thereto at a connection point 28.

The LED 26 may be chosen to transmit the colour which is associated to the material contained within the cylinder 10 of the fire extinguisher held on the stand 24. The LED 24 may be embedded into, or formed integral with the top of the stand 24 or may be mounted on a strip 20 as already described.

Further LEDs 28 are mounted on, or formed within a base 30 of the stand 24. The low position of the LEDs 28 provides the same advantages associated with the low position of the LEDs 18 located on the fire extinguisher cylinder 10. Again, the LEDs 28 may be mounted on a strip 20 as already described.

associated with the low position of the LEDs 18 located on the fire extinguisher cylinder 10. Again, the LEDs 28 may be mounted on a strip 20 as already described.

Although the description refers to the indication devices being LEDs, it is clearly envisaged that they could be any form of light emitting devices.

In a further embodiment, rather than being LEDs, the indication devices provide some sort of audio signal so aid location of the fire extinguisher, or its associated stand, on which the devices are mounted. The indicators could, for example be in the form of speakers or the like. The outputted audio signal may be transmitted in response to a sensed audio signal, such as a whistle.

In a further embodiment the stand 26 may incorporate the indication device which provides a visible or audible signal when the fire extinguisher 10 is removed from the stand 24, the signal ceasing when the extinguisher is placed back on the stand 24 to encourage users to store the fire extinguisher back in its intended position after use and to notify users when the extinguisher is missing from its intended stored location.

The above described embodiments have been given by way of example only, and the skilled reader will naturally appreciate that many variations could be made thereto without departing from the scope of the present invention.

1-16. (canceled)

17. Apparatus for retaining a fire extinguisher the apparatus having a surface not obstructed by the fire extinguisher located on the apparatus in use, the surface having at least one Indicating device mounted thereon to provide a clear indication as to the location of the apparatus.

18. Apparatus according to claim 17, wherein the or at least one Indicating device is located near to or at the base of the apparatus.

19. Apparatus according to claim 17, wherein the or each indicating device provides a visual and/or audio indication of the location of the apparatus.

20. Apparatus according to claim 17, wherein the, or at least one, indicating device is an LED.

21. Apparatus according to claim 20, wherein the or each LED provides a colour that corresponds with a representative colour of the material contained within the fire extinguisher.

22. Apparatus according to claim 20, wherein the or at least one LED is in a position whereupon light is transmitted from the LED to a person in the vicinity of the extinguisher without obstruction.

23. Apparatus according to claim 20, wherein the or at least one LED mounted on a strip.

24. Apparatus according to claim 23, wherein the strip includes means to power the or each LED.

25. Apparatus according to claim 23, wherein the strip is attached to the apparatus by an adhesive.

26. Apparatus according to claim 17, wherein at least one indicating device is mounted on a side surface of the apparatus.

27. Fire extinguishing apparatus comprising a cylindrical body for storing fire-extinguishing material, a handle and a pin, the apparatus having at least one indicating device located around the circumference of the body, near the base thereof, to provide a clear indication as to the location of the apparatus.

28. Apparatus according to claim 27, wherein the or each indicating device provides a visual and/or audio indication of the location of the apparatus.

29. Apparatus according to claim 27, wherein the, or at least one, indicating device is an LED.

30. Apparatus according to claim 29, wherein the or each LED provides a colour that corresponds with a representative colour of the material contained within the fire extinguisher.

31. Apparatus according to claim 29, wherein the or at least one LED is in a position whereupon light is transmitted from the LED to a person in the vicinity of the extinguisher without obstruction.

32. Apparatus according to claim 29, wherein the or at least one LED mounted on a strip.

33. Apparatus according to claim 32, wherein the strip includes means to power the or each LED.

34. Apparatus according to claim 32, wherein the strip is attached to the apparatus by an adhesive.

35. Apparatus according to claim 27, wherein the or one indicating device Is mounted on, or h the immediate vicinity of, the pin.

36. Apparatus according to claim 35, wherein an indicating device is mounted either side of the pin.

37. Apparatus according to claim 27, wherein at least one indicating device is mounted on a side surface of the apparatus.
